(19) United States
(12) Patent Application Publication
(10) Pub. No.: US 2021/0235924 A1
(43) Pub. Date: Aug. 5, 2021

(54) COOKING APPARATUS INCLUDING AN AIR FRYER AND A TEPPANYAKI GRILL

(71) Applicant: Nelson Shen, Dongguan City (CN)

(72) Inventor: Nelson Shen, Dongguan City (CN)

(21) Appl. No.: 16/779,649

(22) Filed: Feb. 2, 2020

(51) Int. Cl. A47J 37/06

(52) U.S. Cl. CPC A47J 37/0647; A47J 37/0682

(57) ABSTRACT

A cooking apparatus includes a body, a gas-burning air flyer and a teppanyaki grill. The gas-burning air fryer includes a frying chamber, a door and a fan. The flying chamber is made in the body. The door is connected to the body and operable to close the frying chamber. The fan is located in the body and operable to circulate air in the flying chamber. The teppanyaki grill includes a metal plate supported on the body.

### BACKGROUND OF INVENTION

### 1. Field of Invention

The present invention relates to a cooking apparatus and, more particularly, to a cooking apparatus including an air fryer and a teppanyaki grill.

### 2. Related Prior Art

A conventional air fryer includes a pot, a fan and an electric heater. The fan and the electric heater are located in the pot. The fan is used to turn air into a vortex in the pot. The electric heater is used to heat the air in the pot.

In use, the heated air flows over food in the pot to evaporate water from the food and draw oil from the food. Thus, the air fryer fries the food without having to use any external oil. The food fried with the air fryer contains 80% less oil than food fried in a conventional manner.

However, the conventional air fryer is not good for outdoor use because it requires electricity to operate. Moreover, the air fryer can only cook a small amount of food at a time for being small. Furthermore, the air fryer provides monotonous use because it can only fry or heat food.

The present invention is therefore intended to obviate or at least alleviate the problems encountered in prior art.

### SUMMARY OF INVENTION

It is an objective of the present invention to provide a cooking apparatus useful in air frying.

It is another objective of the present invention to provide a cooking apparatus useful in teppanyaki.

To achieve the foregoing objectives, the cooking apparatus includes a body, a gas-burning air fryer and a teppanyaki grill. The gas-burning air flyer includes a frying chamber, a door and a fan. The frying chamber is made in the body. The door is connected to the body and operable to close the frying chamber. The fan is located in the body and operable to circulate air in the flying chamber. The teppanyaki grill includes a metal plate supported on the body.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cooking apparatus including an air fryer and a teppanyaki grill according to the preferred embodiment of the present invention;

FIG. 2 is a perspective view of the cooking apparatus in another position than shown in FIG. 1;

FIG. 3 is a perspective view of a gas-burning device of the cooking apparatus shown in FIG. 2;

FIG. 4 is a perspective view of the cooking apparatus in another position than shown in FIG. 2;

FIG. 5 is a partial top view of the cooking apparatus of FIG. 4; and

FIG. 6 is a front view of a box located in a frying chamber made in the cooking apparatus in another position than shown in FIG. 4.

### DETAILED DESCRIPTION OF PREFERRED EMBODIMENT

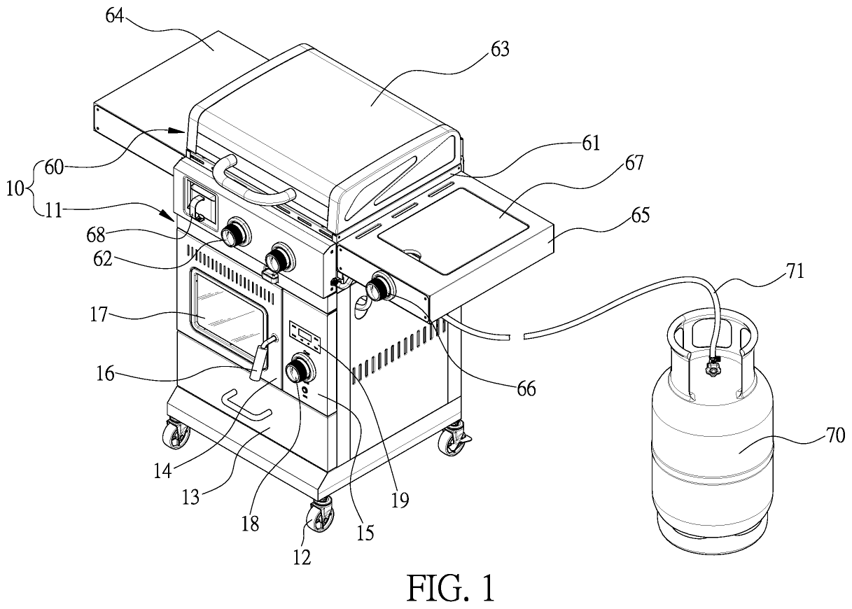

Referring to FIG. 1, a cooking apparatus includes a body 11, an air fryer 10 and a teppanyaki grill 60 according to the preferred embodiment of the present invention.

The cooking apparatus further includes casters 12 connected to a lower face of the body 11. The body 11 is used to support the air fryer 10 and the teppanyaki grill 60. The casters 12 are used to allow smooth moving and steering of the cooking apparatus. A drawer 13 is movably located in the body 11, above the casters 12. A door 14 is pivotally connected to the body 11, above the drawer 13. The door 14 includes a lens 17 through which the interior of the air fryer 10 is observable. A handle 16 is connected to the door 14, in the vicinity of the lens 17. The handle 16 is operable to open or close the door 14. The control panel 15 is supported on the body 11, in the vicinity of the door 14. A switch 18 in the form of a knob is located on the control panel 15. A display 19 is supported on the control panel 15.

The teppanyaki grill 60 includes a connector 61 supported on the body 11. Knobs 62 are located on a front face of the connector 61. A cup 68 is movably located in a bore (not numbered) made in the front face of the connector 61. A cover 63 is pivotally connected to the connector 61. The cover 63 is operable to cover an upper face of the connector 61. Two tables 64 and 65 are pivotally connected to two opposite sides of the connector 61. A knob 66 is located on a front face of the table 65. A lid 67 is pivotally connected to an upper face of the table 65. The lid 67 is operable to close or open a cavity (not numbered) made in the upper face of the table 65.

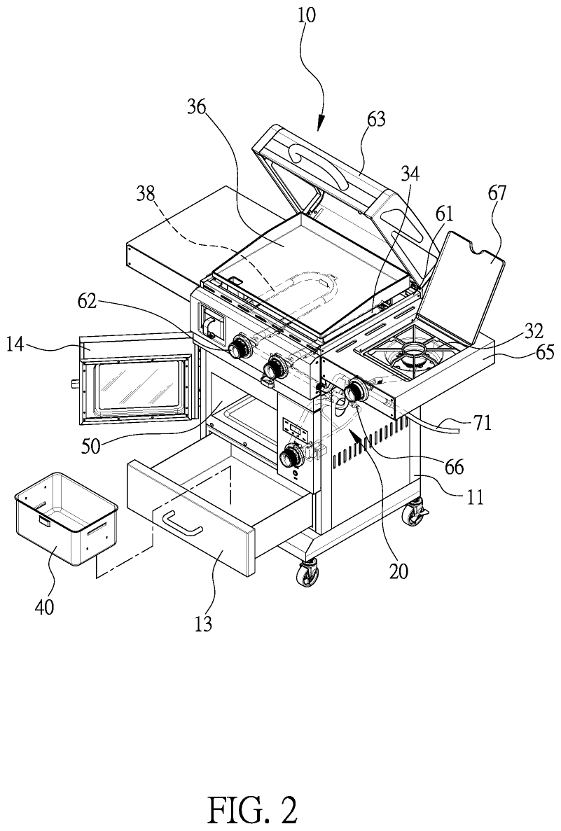

A gas tank 70 is provided next to the body 11. A hose 71 includes an end connected to the gas tank 70 and another end connected to a gas-burning device 20 (FIG. 2) located in the body 11. The gas tank 70 is used to contain gas, natural gas, liquefied petroleum gas or any other proper gas.

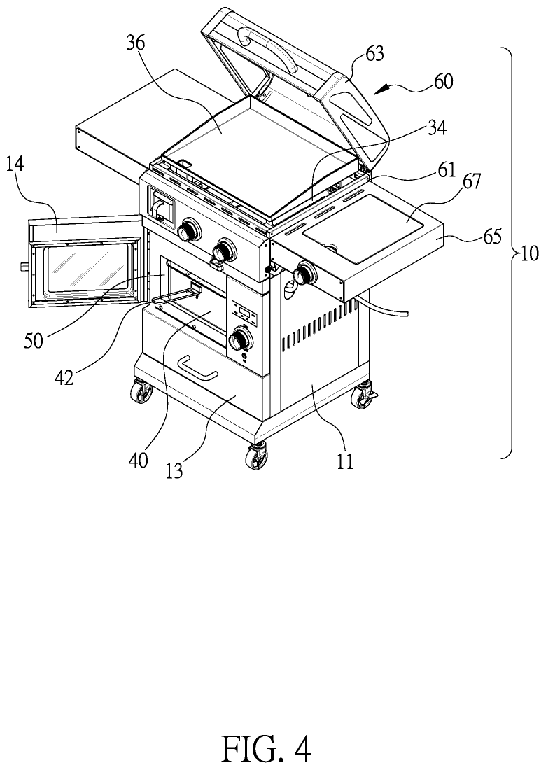

Referring to FIG. 2, the air fryer 10 is in an open position. The drawer 13 is used to contain cooking utensils or other stuff such as a box 40, an auxiliary handle 42 (FIG. 4), dishes, trays, sieves, forks, knives, chopsticks and gloves.

The air fryer 10 includes a flying chamber 50 made in the body 11, above the drawer 13. The door 14 is operable to open or close the frying chamber 50.

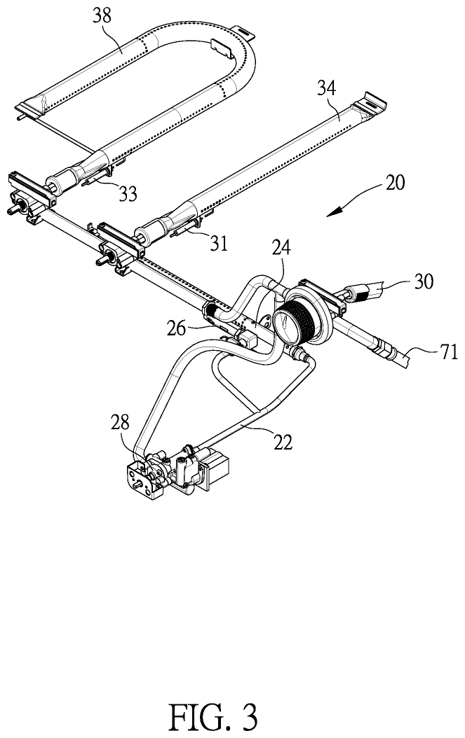

Referring to FIGS. 2 and 3, the gas-burning device 20 is located in the body 11. The gas-burning device 20 includes a fryer piping 22 and a grill piping 30. The grill piping 30 is connected to the hose 71, which is connected to the gas tank 70. The fryer piping 22 is connected to the grill piping 30.

A rectilinear burner 34 and a U-shaped burner 38 are connected to the grill piping 30. An igniter 31 is located in the vicinity of the rectilinear burner 34 so that the igniter 31 is operable to ignite gas at the rectilinear burner 34. An igniter 33 is located in the vicinity of the U-shaped burner 38 so that the igniter 33 is operable to ignite gas at the U-shaped burner 38.

The cooking apparatus includes a circular burner 32 located in the cavity of the table 65. The circular burner 32 is connected to the grill piping 30. The circular burner 32 is operatively connected to the knob 66. The lid 67 is lifted to allow access to the circular burner 32. The knob 66 is operable to control supply of gas to the circular burner 32.

The cover 63 is lifted to allow movement of a metal plate 36 into or from the connector 61. The rectilinear burner 34 and the U-shaped burner 38 are located in the connector 61, below the metal plate 36. The rectilinear burner 34 is connected to a corresponding one of the knobs 62, and so is the U-shaped burner 38. Thus, each of the knobs 62 is operable to control supply of gas to the corresponding one of the burners 34 and 38.

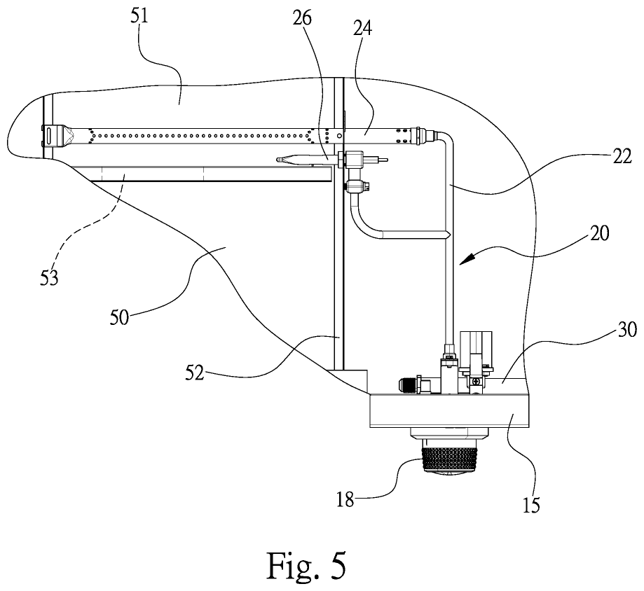

The fryer piping 22 includes a portion connected to a burner 24 and another portion connected to the grill piping 30 via a valve 28. The valve 28 is connected to the switch 18. Thus, the switch 18 is operable to move the valve 28 to control supply of gas to the burner 24. The burner 24 is located in the combustion chamber 51. An igniter 26 is located in the combustion chamber 51 (FIG. 5), in the vicinity of the burner 24. The igniter 26 is connected to the switch 18. Thus, the switch 18 is operable to actuate the igniter 26 to ignite gas at the burner 24 to heat air. Then, the heated air goes into the frying chamber 50 via the channel 53.

Referring to FIG. 4, the cover 63 is lifted to allow access to the metal plate 36. The metal plate 36 is supported on the connector 61, above the burners 34 and 38.

The box 40 and the auxiliary handle 42 are taken from the drawer 13. The auxiliary handle 42 is connected to the box 40. Thus, the auxiliary handle 42 is operable to move the box 40 into or from the frying chamber 50.

Referring to FIG. 5, there are several plates 52 that stand high temperature. The plates 52 are used to separate a combustion chamber 51 from the flying chamber 50. At least one channel 53 is used to connect the combustion chamber 51 to the flying chamber 50. The channel 53 is an aperture made in one of the plates 52 in the preferred embodiment. However, the channel 53 can be surrounded by the plates 52 or between two of the plates 52 in another embodiment.

The burner 24 and an igniter 26 are located in the combustion chamber 51. The switch 18 is operatively operable to control the igniter 26 and the valve 28. The burner 24 is operable to burn the gas to heat air that goes into the frying chamber 50 via the channel 53.

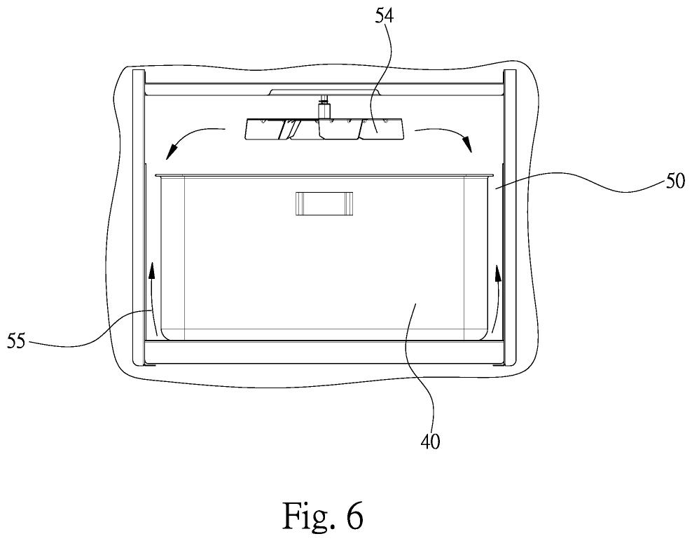

Referring to FIG. 6, a fan 54 is located in the body 11, above the frying chamber 50. The fan 54 is used to circulate the heated air in the frying chamber 50 as indicated by several arrow heads 55. Thus, the heated air travels around the box 40 in the frying chamber 50 to cook food such as chicken, duck and fish contained in the box 40. The heated air is evaporates water from the food and draws oil from the food to fly the food.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A cooking apparatus comprising:
a body;
a gas-burning air flyer comprising a frying chamber made in the body, a door connected to the body and operable to close the frying chamber, and a fan located in the body and operable to circulate air in the frying chamber; and
a teppanyaki grill comprising a metal plate supported on the body.

2. The cooking apparatus according to claim 1, wherein the gas-burning air fryer comprises plates located in the body to separate a combustion chamber from the frying chamber.

3. The cooking apparatus according to claim 2, wherein the gas-burning air fryer comprises a burner located in the combustion chamber.

4. The cooking apparatus according to claim 3, wherein the air fryer comprises a flyer piping, a valves for connecting the fryer piping to the burner, and a switch supported on the body and operable to control supply of gas via the valve and to control ignition of the burner.

5. The cooking apparatus according to claim 2, wherein the air fryer comprises at least one channel between the frying chamber and the combustion chamber.

6. The cooking apparatus according to claim 5, wherein the channel is an aperture made in one of the plates.

7. The cooking apparatus according to claim 5, wherein the channel is surrounded by the plates.

8. The cooking apparatus according to claim 5, wherein the channel is located between two of the plates.

9. The cooking apparatus according to claim 1, wherein the teppanyaki grill comprises a connector located between the metal plate and the body.

10. The cooking apparatus according to claim 9, wherein the teppanyaki grill comprises:
a rectilinear burner located in the connector; and
a knob operatively connected to the rectilinear burner.

11. The cooking apparatus according to claim 10, wherein the teppanyaki grill comprises a grill piping connected to the rectilinear burner via the knob.

12. The cooking apparatus according to claim 9, wherein the teppanyaki grill comprises:
a U-shaped burner located in the connector, and
a knob operatively connected to the U-shaped burner.

13. The cooking apparatus according to claim 12, wherein the teppanyaki grill comprises a grill piping connected to the U-shaped burner via the knob.

14. The cooking apparatus according to claim 9, wherein the teppanyaki grill comprises a table connected to the connector.

15. The cooking apparatus according to claim 14, wherein the teppanyaki grill comprises:
a circular burner supported on the table; and
a grill piping connected to the circular burner.

16. The cooking apparatus according to claim 15, wherein the teppanyaki grill comprises a lid connected to the table and operable to cover the circular burner.
